(19) United States
(12) Patent Application Publication
(10) Pub. No.: US 2024/0155541 A1
(43) Pub. Date: May 9, 2024

(54) POSITIONING METHOD AND APPARATUS

(71) Applicant: VIVO MOBILE COMMUNICATION CO., LTD., Guangdong (CN)

(72) Inventors: Yuanyuan WANG, Guangdong (CN); Ye SI, Guangdong (CN); Huaming WU, Guangdong (CN); Zixun ZHUANG, Guangdong (CN)

(21) Appl. No.: 18/415,930

(22) Filed: Jan. 18, 2024

Related U.S. Application Data
(63) Continuation of application No. PCT/CN2022/106210, filed on Jul. 18, 2022.

(30) Foreign Application Priority Data
Jul. 19, 2021 (CN) 202110815288.8

(51) Int. Cl. H04W 64/00; H04L 5/00; H04W 72/25; H04W 92/18

(52) U.S. Cl. CPC H04W 64/00; H04L 5/0051; H04W 72/25; H04W 92/18

(57) ABSTRACT

This application discloses a positioning method and apparatus. The method includes: transmitting, by a first terminal based on a preset rule, an SL positioning reference signal and/or calculating a TBS, where the preset rule is used to determine a time-frequency mapping method for the SL positioning reference signal and/or a calculation method for the TBS, the SL positioning reference signal is used to determine position information of the first terminal and/or a second terminal, and the second terminal is a peer terminal that performs SL communication or SL positioning with the first terminal.

### CROSS-REFERENCE TO RELATED APPLICATIONS

This application is a Bypass Continuation application of PCT International Application No. PCT/CN2022/106210 filed on Jul. 18, 2022, which claims priority to Chinese Patent Application No. 202110815288.8, filed on Jul. 19, 2021 in China, each of which are incorporated herein by reference in its entirety.

### TECHNICAL FIELD

This application relates to the field of communications technologies, and in particular, to a positioning method and apparatus.

### BACKGROUND

A long term evolution (LTE) system supports sidelink transmission, that is, user equipments (UE) can directly transmit data between each other on a physical layer. An LTE sidelink performs communication via broadcasting. Although being applicable to basic safety-related communication that supports vehicle to everything (V2X), the LTE sidelink is inapplicable to other V2X services of a higher level. A 5G New Radio (NR) system will support more advanced designs of sidelink transmission, such as unicast, broadcast, groupcast, or the like, thereby supporting services of more comprehensive types.

There are various absolute and relative positioning requirements in SL communication, but how to meet corresponding requirements has not been defined.

### SUMMARY

Embodiments of this application aim to provide a positioning method and apparatus. According to a first aspect, a positioning method is provided, including:
transmitting, by a first terminal based on a preset rule, a sidelink (SL) positioning reference signal and/or calculating a transport block size (TBS), where
the preset rule is used to determine a time-frequency mapping method for the SL positioning reference signal and/or a calculation method for the TBS, the SL positioning reference signal is used to determine position information of the first terminal and/or a second terminal, and the second terminal is a peer terminal that performs SL communication or SL positioning with the first terminal.

According to a second aspect, a positioning apparatus is provided, applied to a terminal and including:
a processing module, configured to: transmit an SL positioning reference signal and/or calculate a TBS based on a preset rule, where
the preset rule is used to determine a time-frequency mapping method for the SL positioning reference signal and/or a calculation method for the TBS, the SL positioning reference signal is used to determine position information of the first terminal and/or a second terminal, and the second terminal is a peer terminal that performs SL communication or SL positioning with the first terminal.

According to a third aspect, a terminal is provided, where the terminal includes a processor, a memory, and a program stored in the memory and executable on the processor, and when the program is executed by the processor, steps of the method according to the first aspect are implemented.

According to a fourth aspect, a readable storage medium is provided. The readable storage medium stores a program or an instruction, and when the program or the instruction is executed by a processor, the method according to the first aspect is implemented.

According to a fifth aspect, a computer program product is provided, the computer program product is stored in a non-volatile storage medium, and the computer program product is executed by at least one processor to implement steps of the method according to the first aspect.

According to a sixth aspect, a chip is provided. The chip includes a processor and a communications interface, where the communications interface is coupled to the processor, and the processor is configured to run a program or an instruction to perform the method according to the first aspect.

According to a seventh aspect, a communications device is provided, configured to perform steps of the method according to the first aspect.

### BRIEF DESCRIPTION OF DRAWINGS

FIG. 1a is a schematic diagram of a structure of an existing SL communications system;

FIG. 1B is a schematic flowchart of an existing terminal selecting or reselecting a resource;

FIG. 2 is a schematic flowchart of a positioning method according to an embodiment of this application;

FIG. 3a to FIG. 3m are schematic diagrams of application scenarios according to an embodiment of this application;

FIG. 4a and FIG. 4b are schematic diagrams of application scenarios according to an embodiment of this application;

FIG. 5a and FIG. 5b are schematic diagrams of application scenarios according to an embodiment of this application;

FIG. 6 is a schematic diagram of a structure of a positioning apparatus according to an embodiment of this application; and

FIG. 7 is a schematic diagram of a structure of a terminal according to an embodiment of this application.

### DESCRIPTION OF EMBODIMENTS

The following clearly describes technical solutions in embodiments of this application with reference to accompanying drawings in the embodiments of this application. Apparently, the described embodiments are some but not all of the embodiments of this application. All other embodiments obtained by a person of ordinary skill in the art based on the embodiments of this application without creative efforts shall fall within the protection scope of this application.

The terms “first”, “second”, and the like in the specification and claims of this application are used to distinguish between similar objects instead of describing a designated order or sequence. It should be understood that, the terms used in such a way is interchangeable in proper circumstances, so that the embodiments of this application can be implemented in an order other than the order illustrated or described herein. Objects classified by “first” and “second” are usually of a same type, and the number of objects is not limited. For example, there may be one or more first objects. In addition, in the description and the claims, “and/or” represents at least one of connected objects, and a character “I” generally represents an “or” relationship between associated objects.

It should be noted that, the technologies described in the embodiments of this application are not limited to a Long Term Evolution (LTE)/LTE-Advanced (LTE-A) system, and can also be used in other wireless communications systems such as Code Division Multiple Access (CDMA), Time Division Multiple Access (TDMA), Frequency Division Multiple Access (FDMA), Orthogonal Frequency Division Multiple Access (OFDMA), Single-carrier Frequency-Division Multiple Access (SC-FDMA), and another system. The terms “system” and “network” in the embodiments of this application may be used interchangeably. The technologies described can be applied to both the systems and the radio technologies mentioned above as well as to other systems and radio technologies. However, in the following descriptions, a new radio (NR) system is described for an illustrative purpose, and NR terms are used in most of the following descriptions, although these technologies may also be applied to other applications than an NR system application, for example, the 6^{th} generation (6G) communications system.

To better understand the solution of the embodiments of this application, the following content is first described.

Introduction to V2X

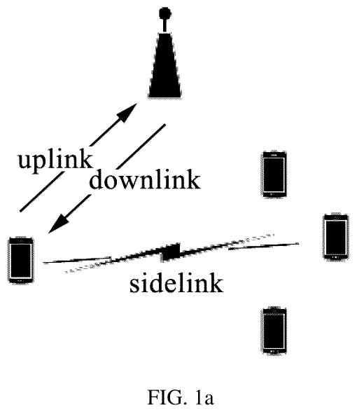

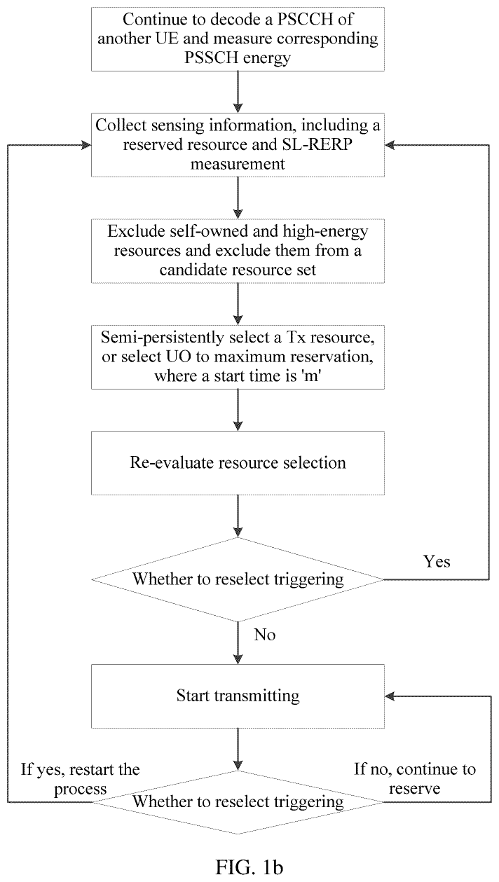

A long term evolution (LTE) system supports sidelink transmission, that is, user equipments (UE) can directly transmit data between each other on a physical layer. FIG. 1a shows a communications system including SL communication. An LTE sidelink performs communication via broadcasting. Although being applicable to basic safety-related communication that supports vehicle to everything (V2X), the LTE sidelink is inapplicable to other V2X services of a higher level. A 5G NR (New Radio) system will support more advanced designs of sidelink transmission, such as unicast, broadcast, groupcast, or the like, thereby supporting services of more comprehensive types.

A long term evolution (LTE) system starts to support a sidelink from a release 12, and the sidelink is used for direct data transmission between user equipments (UE) without using a network device.

Resource Allocation

Two resource allocation modes are defined for an NR V2X. One is a mode 1 in which a base station schedules a resource. The other is a mode 2 in which the UE determines which resource to use for transmission. In this case, resource information may come from a broadcast message of a base station or pre-configured information. If the UE operates in the range of the base station and has radio resource control (RRC) connection to the base station, the UE can operate in the mode 1 and/or the mode 2. If the UE operates in the range of the base station but has no RRC connection to the base station, the UE can operate only in the mode 2. If the UE is out of the range of the base station, the UE can operate only in the mode 2 and perform V2X transmission based on pre-configured information.

A specific operating manner in the mode 2 is as follows. 1) After resource selection is triggered, transmit user equipment (TX UE) first determines a resource selection window, a lower boundary of the resource selection window is at a T1 time after the resource selection is triggered, and an upper boundary of the resource selection window is at a T2 time after the resource selection is triggered, where T2 is a value selected by the UE in a packet delay budget (PDB) transmitted in a transport block (TB) of the UE, and T2 is not earlier than T1. 2) Before resource selection, the UE needs to determine a candidate resource set for resource selection, and compare a reference signal received power (RSRP) measured on the resource within the resource selection window with a corresponding RSRP threshold. If the RSRP is less than the RSRP threshold, the resource may be included in the candidate resource set. 3) After the resource set is determined, the UE randomly selects a transmission resource from the candidate resource set. In addition, the UE can reserve a transmission resource for a next transmission in this transmission. A specific process is shown in FIG. 1B.

A related signal supported by V2X is compared with a UU positioning reference signal. See Table 1 for details.

TABLE 1

| | | R16 PRS (UE | R16 SRS | Sidelink SSB |
|---|---|---|---|---|
| | | receives a | (UE sends a | (Send and |
| Signal feature | | signal) Gold | signal) ZC | receive) ZC |
| SCS CP point A | | Not related to | Within | Within |
| | | BWP | BWP | SL-FreqConfig |
| | | | | AbsoluteFrequencySSB- |
| StartPRB | | INTEGER | | r16 SCS is the same |
| | | (0 . . . 2176) | | as SL BWP |
| Bandwidth | | 24:4:272 | Cₛᵣₛ, B_{SRS} = 0 | 11 RB within a |
| | | (PRB) | | bandwidth of the |
| | | | | SL BWP index 0 in |
| | | | | the S-SS/PSBCH |
| | | | | block is aligned |
| | | | | with a subcarrier |
| | | | | with index 0 in an |
| | | | | RB of the SL BWP. |
| CombSizeN | | N = {2, 4, 6, 12} | | 1 |
| Port | | Single port | | |
| SL-ResourcePool | sl-TimeResource | / | | |
| | sl-NumSubchannel | | | |
| | sl-StartRB-Subchannel | | | |
| Set level | Maxnumofset | 2 | 16 | 3 |
| | | | | sl-SSB- |
| | | | | TimeAllocation |
| | Periodicity | 2^{μ} {4, | Periodicity | sl-NumSSB- |
| | | 8 . . . 20480} | Semi-static | WithinPeriod |
| | | | Aperiodic | FR1, SCS = 15 1, |
| | | | | 2 |
| | | | | FR1, SCS = 30 1, |
| | | | | 2, 4 |
| | | | | FR1, SCS = 60 1, |
| | | | | 2, 4, 8 |
| | | | | FR2, SCS = 60 1, |
| | | | | 2, 4, 8, 16, 32 |
| | | | | FR2, SCS = 120: |
| | | | | 1, 2, 4, 8, 16, 32, |
| | | | | 64 |
| | SFN0-Offset | us(Tx} | / | TimeInterval |
| | | synchronization | | (0 . . . 639) |
| | | issue) | | |
| | ResourceSetSlotOffse | T_{offset}^{PRS} ∈ {0, 1 . . . | | TimeOffsetSSB |
| | | Tₚₑᵣ^{PRS}} | | (0 . . . 1279) |
| | RepetitionFactor | Tᵣₑₚ^{PRS} ∈ {1, 2, 4, 6, | | / |
| | | 8, 16, 32} | | |
| | TimeGap | T_{gap}^{PRS} ∈ {1, 2, 4, 6, | | |
| | | 8, 16, 32} | | |
| | MutingPattern | {2, 4, 8, 16, | | |
| | | 32} | | |
| | MutingBitRepetitionFactor | {1, 2, 4, 8} | | |
| | Power | | Alpa, | SL-RSRP-Range |
| | | | po | |
| | | | PathlossRS | |
| | | | poweradjust | |
| resource | SequenceId | {0, . . . , 4095} | {0 . . . , 65536} | sl-SSID-r16 |
| level | | objective, | objective, | INTEGER |
| | | distinguish | distinguish | (0 . . . 671) |
| | | between cells | between UEs | N_{ID, 1}^{SL} |
| | | | | ∈ {0, 1, . . . , 335} |
| | | | | N_{ID, 2}^{SL} ∈ {0, 1} |
| | | | | obtain a time, and |
| | | | | indicate a time |
| | | | | source |
| | Number of | 64 | 16 | |
| | Resources | | | |
| | ReOffset | | RE&comb | 2, 3, . . . , 127, 128 |
| | Slotoffset | {0, . . . 512} | / | |
| | symbolOffset | {0, 1, 2, . . . , | 0-13 | PSS: 1, 2 |
| | | 12} | | Sss3, 4 |
| | NumSymbols | {2, 4, 6, | 1 2 4 8 12 | |
| | | 12}symbols | | |
| | QCL-Info or sptial | | | |
| | relation | | | |
| | Periodicity | / | Periodicity | |
| | | | &Offset | |
| | Frequency hopping | / | / | |
| Measurement | DL-PRS-expected | +/− 500 us; | | |
| configuration | RSTD | Granularity: | | |
| | | 4Ts | | |
| | expectedRSTD- | +/− 32 us FR2: | | |
| | uncertainty | +/− 8 us | | |
| | DL-PRS- | ID | | |
| | RstdReferenceInfo | | | |
| | measurement gap | | / | |
| | SFNInitializationTime | / | | |
| Measurement | Timestamp | SFN, SLOT | | |
| report | TimingMeasQuality.Value | {0.1, . . . , 31} | | |
| | TimingMeasQuality.Resolution | {0.1 m, 1 m, | | |
| | | 10 m, 30 m} | | |
| | RSTD\TOA or | | | |
| | Relative pos | | | |

| | | | | Sidelink |
|---|---|---|---|---|
| | | Sidelink | Sidelink | PTRS |
| | | CSI-RS | DMRS | (precoding) |
| | | (unicast | (precoding) | Only for |
| Signal feature | | only) | Gold | FR2 Gold |
| SCS CP point A | | Within | WithinBWP | Within |
| | | WP | (BWP | BWP, |
| | | (BWP | further | PSSCH |
| | | further | includes a | (BWP |
| StartPRB | | includes a | symbol), | further |
| | | symbol), | PSSCH | includes a |
| | | PSSCH | | symbol) |
| Bandwidth | | | | RB offset: |
| | | | | determined |
| | | | | based on |
| | | | | the n_CRC |
| CombSizeN | | density | PSCCH, comb 4 | FreqDensity- |
| | | p = 1 == | PSSCH, comb 2 | SEQUENCE |
| | | comb 12 | Exact DMRS pattern? | (SIZE |
| | | 7.4.1.5.3-1 | SCI indication | (2)) OF |
| | | | sl-PSSCH-DMRS- | INTEGER |
| | | | TimePatternList | (1 . . . 276) |
| | | | | According |
| | | | | to Table |
| | | | | 214 |
| Port | | 1 or 2 | same (same), PSCCH is a fixed port, | |
| | | antenna | and PSSCH can be 1 or 2 port(s). | |
| | | port(s) | Mapping relationship between the | |
| | | | number of ports and the port number | |
| | | | is fixed | |
| SL-ResourcePool | sl-TimeResource | | INTEGER (10 . . . 160) | |
| | sl-NumSubchannel | | INTEGER (0 . . . 265) | |
| | sl-StartRB-Subchannel | | INTEGER (1 . . . 27) | |
| Set level | Maxnumofset | | | |
| | Periodicity | | | TimeDensity- |
| | | | | SEQUENCE |
| | | | | (SIZE |
| | | | | (3)) OF |
| | | | | INTEGER |
| | | | | (0 . . . 29) |
| | SFNO-Offset | | | |
| | ResourceSetSlotOffse | | / | |
| | RepetitionFactor | | | |
| | TimeGap | | | |
| | MutingPattern | | | |
| | MutingBitRepetitionFactor | | | |
| | Power | β_{CSIRS} | | |
| resource | SequenceId | n_ID is | PSCCH | N_{ID}^{X} equals |
| level | | determined | sl-DMRS-ScrambleID-r16 | the decimal |
| | | by the | INTEGER (0 . . . 65535) | representation |
| | | 10-bit | PSSCH , comb 2 CRC | of CRC on |
| | | LSB of | | the PSCCH |
| | | CRC | | associated |
| | | | | with the |
| | | | | PSSCH |
| | Number of | | | |
| | Resources | | | |
| | ReOffset | | k is relative to | RE-Offset |
| | | | subcarrier 0 in | ENUMERATED |
| | | | common resource | {offset01, |
| | | | block 0 | offset10, |
| | | | PSCCH: k′ = 0, 1, 2 | offset11} |
| | Slotoffset | | | |
| | symbolOffset | | 8.4.1.1.2-1 | |
| | | | 2.3.4 symbols; | |
| | NumSymbols | | different | |
| | | | combinations | |
| | | | 1 is relative to | |
| | | | PSCCH or PSSCH | |
| | QCL-Info or sptial | | | |
| | relation | | | |
| | Periodicity | | | |
| | Frequency hopping | | | |
| Measurement | DL-PRS-expected | PC5 | | |
| configuration | RSTD | RRC | | |
| | | configuration | | |
| | expectedRSTD- | | | |
| | uncertainty | | | |
| | DL-PRS- | | | |
| | RstdReferenceInfo | | | |
| | measurement gap | | | |
| | SFNInitializationTime | | | |
| Measurement | Timestamp | | | |
| report | TimingMeasQuality.Value | | | |
| | TimingMeasQuality.Resolution | | | |
| | RSTD\TOA or | | | |
| | Relative pos | | | |

With reference to the accompanying drawings, the following describes in detail the method and apparatus in the embodiments of this application based on specific embodiments and application scenarios thereof.

It should be noted that the terminal in this embodiment of this application may be a terminal side device such as a mobile phone, a tablet personal computer, a laptop computer or a notebook computer, a personal digital assistant (PDA), a palmtop computer, a netbook, an ultra-mobile personal computer (UMPC), a mobile Internet device (MID), a wearable device, vehicle user equipment (VUE), or pedestrian user equipment (PUE). The wearable device includes a bracelet, a headset, glasses, or the like. It should be noted that a specific type of the terminal is not limited in this embodiment of this application.

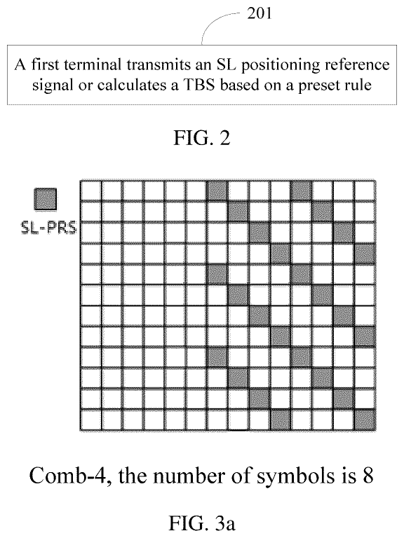

Referring to FIG. 2, an embodiment of this application provides a positioning method.

It should be noted that this embodiment of this application is applied to the SL communications scenario, and communications devices involved are a pair of terminals in SL communication, namely, a first terminal and a second terminal. The first terminal and the second terminal can be a sending terminal or a receiving terminal for each other, that is, the first terminal can be the sending terminal, and the second terminal can be the receiving terminal, or the first terminal can be the receiving terminal, and the second terminal can be the sending terminal. In another application scenario, a scheduling terminal can also be set in the SL communications system. Correspondingly, the first terminal and the second terminal can also be the scheduling terminal and the sending terminal respectively, or the scheduling terminal and the receiving terminal respectively. Correspondingly, there may be a scheduling terminal that schedules the first terminal to send and/or the second terminal to receive. Alternatively, the first terminal is the scheduling terminal, the second terminal is a scheduled terminal, and vice versa.

Alternatively, the first terminal can also be a control node of the second terminal, for example, in groupcast, header UE schedules a pair of UEs for transmission.

The method in this embodiment of this application can be used in all of the above cases, and the following uses the first terminal as an execution entity for description. It can be understood that the first terminal can be used as the sending terminal, the receiving terminal, or the scheduling terminal in SL communication.

The specific steps of the method include: step 201.

Step 201: A first terminal transmits an SL positioning reference signal or calculates a TBS based on a preset rule.

In this embodiment of this application, the SL positioning reference signal (SL-PRS) is used to determine position information of the first terminal and/or the second terminal, and the second terminal is a peer terminal that performs SL communication or SL positioning with the first terminal.

As described in the above application scenario, communication between the first terminal and the second terminal can specifically be 1) data transmission between the sending terminal and the receiving terminal; 2) information interaction between the scheduling terminal and the sending terminal; and 3) information interaction between the scheduling terminal and the receiving terminal. This is not limited in this embodiment of this application.

The preset rule is used to determine a time-frequency mapping method for the SL positioning reference signal and/or a calculation method for the transport block size (TBS), so that the first terminal can send the SL positioning reference signal to the peer end based on the preset rule, and the first terminal can calculate the TBS based on the preset rule.

In this embodiment of this application, the preset rule that is used to determine the time-frequency mapping method for the SL positioning reference signal and/or the calculation method for the TBS is used to transmit the SL positioning reference signal between the first terminal and the second terminal, and the first terminal calculates the TBS, to meet positioning requirements in SL communication.

In a possible implementation, the preset rule is used to determine the time-frequency mapping method for the SL positioning reference signal, and the time-frequency mapping method includes one or more of the following:
(1) continuously sending the SL positioning reference signal on an OFDM symbol or a resource element (RE) other than a first position;
(2) sending the SL positioning reference signal on an OFDM symbol or an RE after the first position;
(3) sending the SL positioning reference signal on an OFDM symbol or an RE other than the first position;
(4) not sending the SL positioning reference signal on an OFDM symbol or an RE corresponding to the first position; and
(5) multiplexing the SL positioning reference signal at a second position, or performing, by the SL positioning reference signal, punching at the second position, where
the first position includes one or more of the following:
(a) time domain positions of a sidelink synchronization signal block (S-SS block), a sidelink primary synchronization signal block (S-PSS block), a sidelink secondary synchronization signal block (S-SSS block), and/or a physical sidelink broadcast channel block (PSBCH block), or time-frequency positions of the S-SS block, the S-PSS block, the S-SSS block, and/or the PSBCH block, for example, the SL positioning reference signal is from an X^{th} symbol to an (X+M−1)^{th} symbol;
(b) time domain positions of a PSS, an SSS, and/or a physical broadcast synchronization channel (PBSCH), or time-frequency positions of the PSS, the SSS, and/or the PBSCH, for example, the SL positioning reference signal is from an X^{th} symbol to an (X+M−1)^{th} symbol;
(c) time domain positions/a time domain position of a physical sidelink control channel (PSCCH) (or first-level SCI) and/or second-level sidelink control information (SCI), or time-frequency positions/a time-frequency position of the PSCCH and/or the second-level SCI;
(d) time domain positions/a time domain position of a sidelink channel-state information reference signal (SL-CSI-RS) and/or an SL-TPRS, or time-frequency positions/a time-frequency position of the SL-CSI-RS and/or the SL-TPRS;
(e) time domain positions/a time domain position of a CSI-RS and/or a demodulation reference signal (DMRS), or time-frequency positions/a time-frequency position of the CSI-RS and/or the DMRS, for example, the SL positioning reference signal is from an X^{th} symbol to an (X+M−1)^{th} symbol; and
(f) time domain positions of automatic gain control (AGC), a guard period (GP), and/or a physical sidelink feedback channel (PSFCH), or time-frequency positions of the AGC, the GP, and/or the PSFCH, and it should be noted that the AGC can be specifically understood as sending repetition information or signals on two or more symbols in the protocol.

Further, it can be understood that if the first position exists on the OFDM on which the SL positioning reference signal sends a signal, such as (a first symbol sends a synchronization signal and a physical broadcast channel block (SSB)), the SL positioning reference signal is not sent at the position, or a next first symbol that is not at the first position is sent.

The second position includes one or more of the following:
(a) a position of a physical sidelink control channel (PSSCH);
(b) a position of SL data;
(c) a position of uplink (UL) data; and
(d) a position of a physical uplink shared channel (PUSCH).

In a possible implementation, the preset rule includes a second-level SCI mapping rule, which can be further understood as that the preset mapping rule may be a mapping rule of the second-level SCI, through which the SL-PRS can be indirectly determined.

The preset rule includes one or more of the following:
(1) the second-level SCI performs punching on the SL positioning reference signal, and optionally, when the RE of the PRS is less than a threshold, the second-level SCI performs punching on the SL positioning reference signal;
(2) the second-level SCI performs rate matching on the SL positioning reference signal, and optionally, when the RE of the PRS is greater than a threshold, the second-level SCI performs rate matching on the SL positioning reference signal;
(3) the PSFCH performs punching on the SL positioning reference signal, and optionally, when the RE of the PRS is less than a threshold, the PSFCH performs punching on the SL positioning reference signal; and
(4) the PSFCH performs rate matching on the SL positioning reference signal.

Optionally, when the RE of the PRS is greater than a threshold, the PSFCH performs rate matching on the SL positioning reference signal.

In a possible implementation, the sending the SL positioning reference signal on an RE other than a first position includes:
sending the SL positioning reference signal on the OFDM symbol corresponding to the first position, and sending other SL information on the OFDM symbol corresponding to the first position through FDM or CDM.

For example, now the SL DMRS is comb 2, another ½ of the resource can be used to send the SL-PRS. In addition, if PRS multiplexing is transmitted in a PSSCH bandwidth, it is required to consider FDM with SL DMRS, CSI-RS, or the like.

In a possible implementation, the preset rule includes one or more of the following:
(1) the SL positioning reference signal is continuously sent on a frequency domain PRB, an RE, or a symbol other than the third position, for example, the SL positioning reference signal is from an X^{th} symbol to an (X+M−1)^{th} symbol;
(2) the SL positioning reference signal is continuously sent on a frequency domain PRB, an RE, or a symbol after the third position, for example, the SL positioning reference signal is from an X^{th} symbol to an (X+M−1)^{th} symbol;
(3) the SL positioning reference signal is sent on a frequency domain PRB, an RE, or a symbol other than the third position, for example, the SL positioning reference signal is from an X^{th} symbol to an (X+M−1)^{th} symbol;
(4) the SL positioning reference signal is not sent on a PRB, an RE, or a symbol corresponding to the third position, for example, the SL positioning reference signal is from an X^{th} symbol to an (X+M−1)^{th} symbol; and
(5) the SL positioning reference signal is multiplexed at a fourth position, or the SL positioning reference signal performs punching at the fourth position.

The third position includes one or more of the following:
(a) frequency domain positions of an S-SS block, an S-PSS block, an S-SSS block, and/or a PSBCH block, or time-frequency positions of the S-SS block, the S-PSS block, the S-SSS block, and/or the PSBCH block;
(b) frequency domain positions of a PSS, an SSS, and/or a PBSCH, or time-frequency positions of the PSS, the SSS, and/or the PBSCH;
(c) frequency domain positions/a frequency domain position of a PSCCH and/or second-level SCI, or time-frequency positions/a time-frequency position of the PSCCH and/or the second-level SCI;
(d) time domain positions/a time domain position of a CSI-RS and/or a DMRS, or time-frequency positions/a time-frequency position of the CSI-RS and/or the DMRS; and
(e) frequency domain positions of AGC, a GP, and/or a PSFCH, or time-frequency positions of the AGC, the GP, and/or the PSFCH.

Further, it can be understood that if the third position exists on the frequency domain PRB/RE on which the SL positioning reference signal sends a signal, such as (a first PRB/RE sends an SSB), the SL positioning reference signal is not sent at the position, or is sent at a next first frequency domain position other than the first position.

The fourth position includes one or more of the following:
(a) a position of a PSSCH;
(b) a position of SL data;
(c) a position of UL data; and
(d) a position of a PUSCH.

In a possible implementation, the preset rule is used to determine a first calculation method for the TBS;

the first calculation method includes:
(1) when the first terminal calculates an RE of an available resource, subtracting an overhead of the SL positioning reference signal, where a calculation formula is as follows:

N′_{RE}=N_{sc}^{RB}(N_{symb}^{sh}−N_{symb}^{PSFCH})−Nₒₕ^{PRB}−N_{RE}^{DMRS}−N_{RE}^{SL-PRS}, where
N_{sc}^{RB} is the number of REs in one RB, N_{symb}^{sh} is the number of symbols scheduled in one slot, N_{symb}^{PSFCH} is the number of symbols in a PSFCH, Nₒₕ^{PRB} is a higher layer configuration parameter, N_{RE}^{DMRS} is an overhead of a DMRS, and N_{RE}^{SL-PRS} is an overhead of the SL positioning reference signal; and
the overhead of the SL positioning reference signal includes any one or more of the following:
(a) the overhead of the SL positioning reference signal is 0 or a preset value;
(b) the overhead of the SL positioning reference signal is an actual overhead on the symbol;
(c) the overhead of the SL positioning reference signal is an average overhead on the symbol;
(d) the overhead of the SL positioning reference signal is a quantized value of the actual overhead on the symbol;
(e) the overhead of the SL positioning reference signal is related to configuration information of the SL positioning reference signal or a pattern of the SL positioning reference signal;
for example, the protocol predefines a table between the PRS pattern and the overhead. As shown in Table 2, the overhead of the PRS is determined by using PRS configuration+table indicated by the SCI;

TABLE 2

| sl-PSSCH-PRS-TimePatternList | N_{RE}^{PRS} |
|---|---|
| 1 | 12 |
| 2 | 18 |
| 3 | 24 |
| 4 | 15 |
| 5 | 18 |
| 6 | 21 |
| 7 | 18 |

for another example, if the overhead of the SL positioning reference signal is set to a fixed overhead value, such as N=10, 20, or the like, a corresponding calculation formula is:

N′_{RE}=N_{sc}^{RB}(N_{symb}^{sh}−N_{symb}^{PSFCH})−Nₒₕ^{PRB}−N_{RE}^{DMRS}−N;
(f) the overhead of the SL positioning reference signal is an overhead of the SL positioning reference signal configured by a higher layer;
(g) the overhead of the SL positioning reference signal is an overhead of the SL positioning reference signal indicated by SCI;
(h) the overhead of the SL positioning reference signal is to subtract the overhead of the SL positioning reference signal when determining, based on first indication information, that the first terminal calculates an RE of an available resource, or to keep the overhead of the SL positioning reference signal when determining that the first terminal calculates the RE of the available resource; and
(i) the overhead of the SL positioning reference signal is to subtract the overhead of the SL positioning reference signal when determining, based on condition information, that the first terminal calculates an RE of an available resource of a resource, or to keep the overhead of the SL positioning reference signal when determining that the first terminal calculates the RE of the available resource, where the condition information is a configuration and/or the number of the SL positioning reference signals.

In a possible implementation, the preset rule is used to determine a second calculation method for the TBS;
the second calculation method includes any one or more of the following:
(1) when the first terminal calculates an RE of an available resource on a PRB, subtracting an overhead of the SL positioning reference signal and being multiplied by a scaling factor, where a calculation formula is as follows:

N′_{RE}=N_{sc}^{RB}(N_{symb}^{sh}−N_{symb}^{PSFCH})−Nₒₕ^{PRB}−N_{RE}^{DMRS}−N_{RE}^{SL-PRS}×alpha, where
alpha is a scaling factor of N_{RE}^{SL-PRS};
the overhead of the SL positioning reference signal includes any one or more of the following:
(a) the overhead of the SL positioning reference signal is 0 or a preset value;
(b) the overhead of the SL positioning reference signal is an actual overhead on the symbol;
(c) the overhead of the SL positioning reference signal is an average overhead on the symbol, where if there are a plurality of SL positioning signals, or a plurality of SL positioning signals are on the same number of symbols, an average value is used as the overhead of the SL positioning reference signal, and this average value can be a statistically average value or an average value of a plurality of actual symbols;
(d) the overhead of the SL positioning reference signal is a quantized value of the actual overhead on the symbol; and
(e) the overhead of the SL positioning reference signal is related to configuration information of the SL positioning reference signal or a pattern of the SL positioning reference signal;
(f) the overhead of the SL positioning reference signal is an overhead of the SL positioning reference signal configured by a higher layer;
(g) the overhead of the SL positioning reference signal is an overhead of the SL positioning reference signal indicated by SCI;
(h) the overhead of the SL positioning reference signal is to subtract the overhead of the SL positioning reference signal when determining, based on first indication information, that the first terminal calculates an RE of an available resource, or to keep the overhead of the SL positioning reference signal when determining that the first terminal calculates the RE of the available resource; and
(i) the overhead of the SL positioning reference signal is to subtract the overhead of the SL positioning reference signal when determining, based on condition information, that the first terminal calculates an RE of an available resource of a resource, or to keep the overhead of the SL positioning reference signal when determining that the first terminal calculates the RE of the available resource, where the condition information is a configuration and/or the number of the SL positioning reference signals; and
(2) performing, by the first terminal, scaling on a scheduled PRB, and calculating the total number of REs, where a calculation formula is as follows:

N_{RE}=min(A,N′_{RE})·alpha, where
A is a preset parameter; and alpha is a scaling factor of the scheduled PRB; and
performing, by the first terminal, scaling on intermediate information of the TBS obtained through calculation, where a calculation formula is as follows:

N_{info}=N_{RE}·R·Qₘ·v·alpha, where
R is a code rate, Qₘ is a modulation order, v is the number of transport layers; and alpha is a scaling factor of the intermediate information of the TBS.

In a possible implementation, the preset rule includes a third calculation rule of the TBS of the SL positioning reference signal; and
the third calculation rule includes any one of the following:
the first terminal calculates an overhead of a resource and subtracts the overhead of the SL positioning reference signal, and a calculation formula is as follows:

N′_{RE}=N_{sc}^{RB}(N_{symb}^{sh}−N_{symb}^{PSFCH})−Nₒₕ^{PRB}−N_{RE}^{DMRS}−N_{RE}^{SL-PRS}, where
N_{RE}^{SL-PRS} is associated with an RE or a symbol of the SL positioning reference signal on the PSSCH resource or a scheduling resource; or
the calculation formula is as follows:

N′_{RE}=N_{sc}^{RB}(N_{symb}^{sh}−N_{symb}^{PSFCH})−Nₒₕ^{PRB}−N_{RE}^{DMRS}−N_{RE}^{SL-PRS}+compensation value, where
a compensation value includes: values of the SL positioning reference signal and second-level SCI and/or a value of an overlapping part of a PSSCH; or
the compensation value includes a recalculated part, and the recalculated part refers to a part repeatedly subtracted in the previous calculation process, such as SL-PRS included in N_{symb}^{PSFCH} which has been subtracted once.

Optionally, in some implementations, in a case that the SL positioning reference signal is mapped on a non-PSSCH resource or a non-scheduling resource, the first terminal calculates the overhead of the resource and subtracts the overhead of the SL positioning reference signal.

In a possible implementation, as for how to send and map the SL positioning reference signal when a plurality of layers are included, the method is as follows:

in a case that the number of transport layers is greater than 1, the preset rule includes any one of the following:

(1) the first terminal repeatedly sends or maps the SL positioning reference signal on a plurality of transport layers; and

(2) the first terminal sends or maps the SL positioning reference signal of a plurality of code division or orthogonal cover codes (OCC) on the plurality of transport layers.

In a possible implementation, the preset rule includes second indication information, and the second indication information is used to determine that initial transmission and retransmission of the SL positioning reference signal are consistent; and
the second indication information includes one or more of the following:
(1) first-level SCI or second-level SCI indicates an overhead of the SL positioning reference signal;
(2) a higher layer configures the overhead of the SL positioning reference signal;
(3) indication information of the SL positioning reference signal or configuration information of the SL positioning reference signal;
(4) first information, used to indicate that a configuration and/or a pattern of the SL positioning reference signal sent for many times are/is consistent in a case that a resource of the SL positioning reference signal sent for many times is used for retransmission; and
(5) second information, where in a case that the second information is a first value (for example, the first value is 1), the second information indicates that a configuration and/or a pattern of the SL positioning reference signal sent for many times are/is consistent in a case that a resource of the SL positioning reference signal sent for many times is used for retransmission. That is, corresponding content is indicated in an implicit indication manner.

In a possible implementation, the method further includes:
(1) expecting, by the first terminal, that the number of REs occupied by the SL positioning reference signal in initial transmission is consistent with the number of REs occupied by the SL positioning reference signal in retransmission; or
(2) expecting, by the first terminal based on indication of a network side, that the number of REs occupied by the SL positioning reference signal in initial transmission is consistent with the number of REs occupied by the SL positioning reference signal in retransmission.

In a possible implementation, in a case that the number of REs occupied by the SL positioning reference signal in initial transmission is not consistent with the number of REs occupied by the SL positioning reference signal in retransmission, the method further includes:
receiving, by the first terminal, third indication information from the second terminal, where the third indication information is used to determine that a TBS of the SL positioning reference signal in initial transmission is consistent with the TBS of the SL positioning reference signal in retransmission. For example, a specific entry of modulation and coding scheme (MCS) of multiplexing NR is used for indication.

The third indication information includes one or more of the following:
(1) first-level SCI or second-level SCI indicates an overhead of the SL positioning reference signal;
(2) a higher layer configures the overhead of the SL positioning reference signal;
(3) indication information of the SL positioning reference signal or configuration information of the SL positioning reference signal; and
(4) second information, used to indicate that a configuration and/or a pattern of the SL positioning reference signal sent for many times are/is consistent in a case that a resource of the SL positioning reference signal sent for many times is used for retransmission.

In a possible implementation, the method further includes:
determining the overhead of the SL positioning reference signal configured by the higher layer, and the indication information or the condition information of the SL positioning reference signal in one or more of the following manners:
(1) being determined by the first terminal based on SCI;
(2) being determined by the first terminal based on RRC configuration negotiation or RRC feedback;
for example, the sending terminal UE sends indication information to indicate whether to subtract the overhead of the SL-PRS and a size of the overhead in calculation of the SL TBS, and the indication information further includes configuration information or indication information of the SL-PRS;
for example, an overhead set is configured through SL-RRC, and it is indicated in SCI that the overhead is a value in the set;
for example, being obtained through feedback information, and the feedback information carries an overhead indication. It is indicated whether a corresponding overhead is included, and/or a size of the overhead. For example, the receiving terminal indicates, in the feedback information for the sending terminal, whether to subtract a resource overhead of AGC in calculation;
(3) being determined by the first terminal based on PC5 RRC configuration negotiation or RRC feedback;
(4) being determined by the first terminal based on Long Term Evolution Positioning Protocol (LPP) configuration negotiation feedback;
(5) being determined by the first terminal based on PC5 LPP configuration negotiation feedback;
(6) in a case that a PSFCH period is a preset period (for example, the period is 2 or 3) or a preset configuration, being determined by the first terminal based on a PSFCH overhead indication carried in SCI; and
(7) in a case that the preset configuration is met, being determined by the first terminal based on an overhead indication of the SL positioning reference signal carried in the SCI, where the preset configuration may be any one of the following:
(a) the SL positioning reference signal is included in a reserved resource;
(b) the RE of the SL positioning reference signal>threshold 1; and
(c) a channel condition RSRP<threshold.

The following describes technical solutions of this application with reference to specific embodiments.

1. Pattern Feature

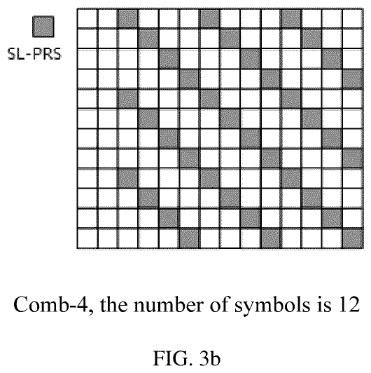

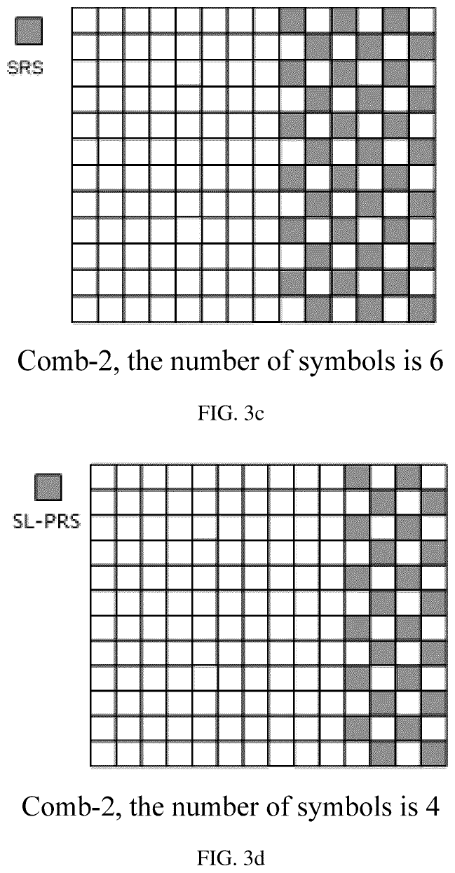

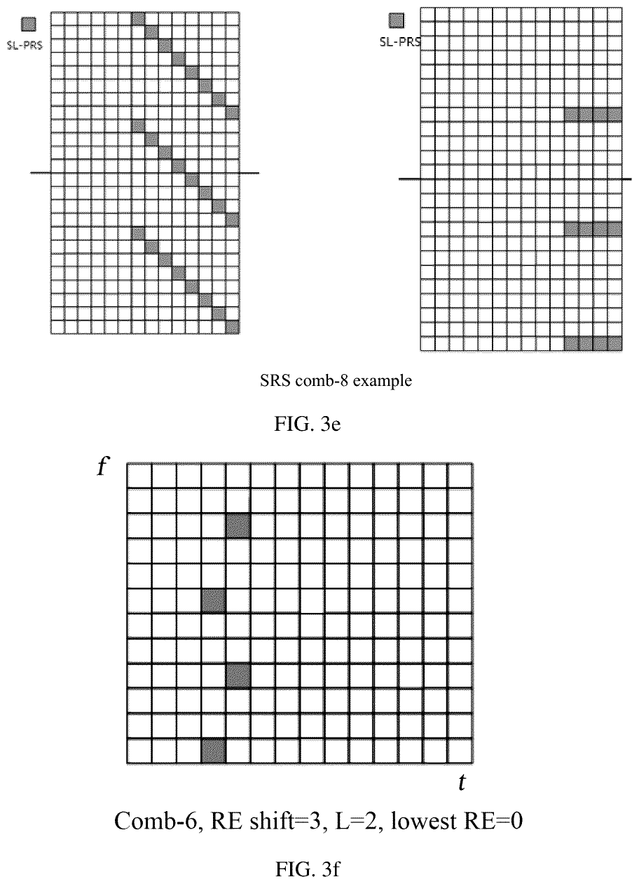

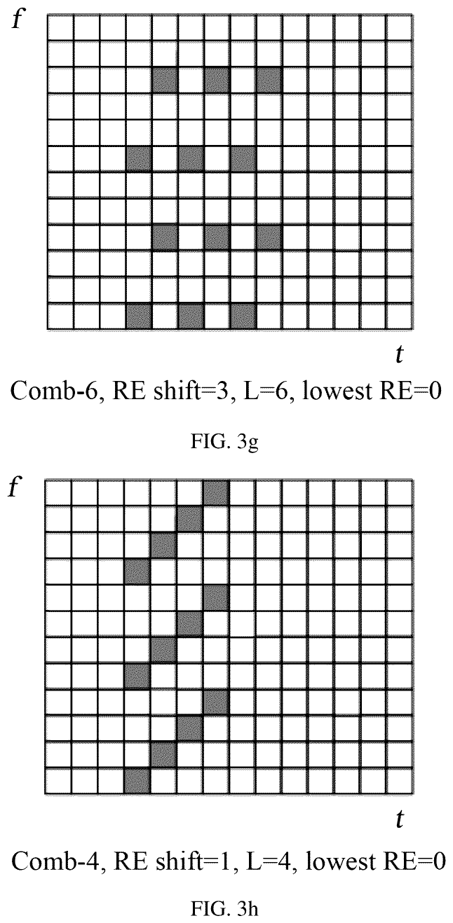

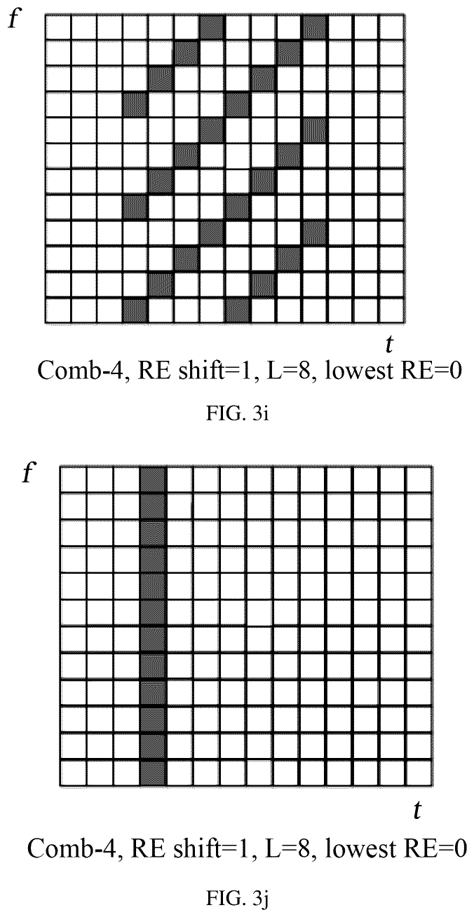

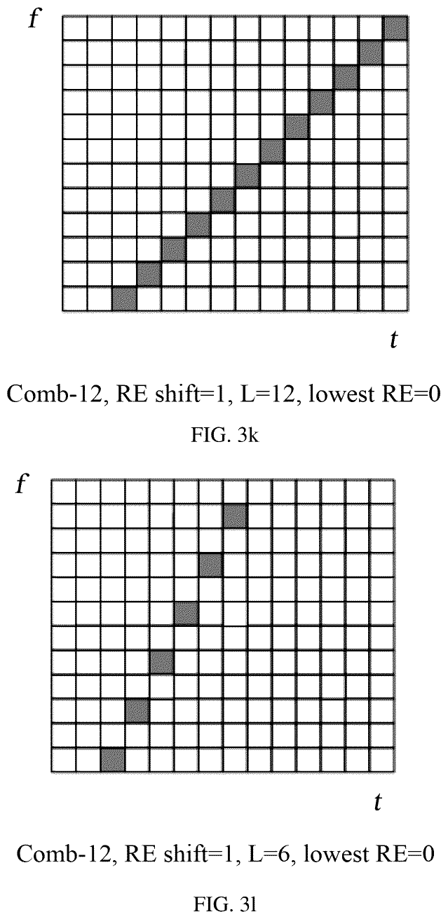

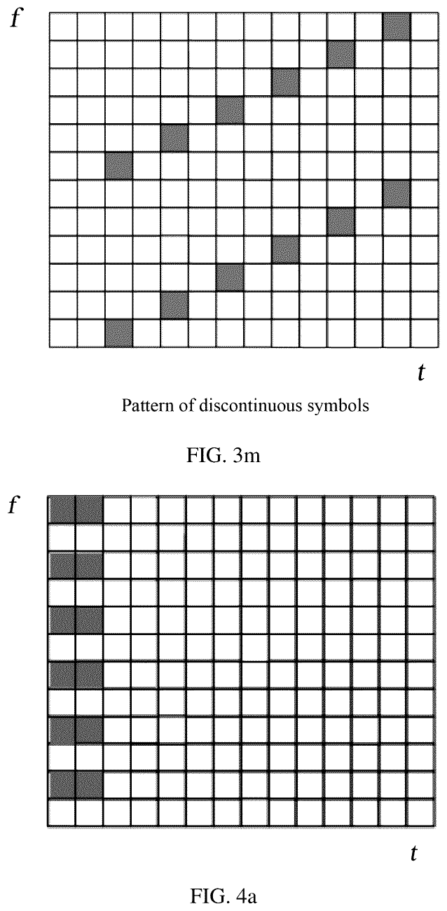

FIG. 3a to FIG. 3m show a pattern of the SL positioning reference signal.

It should be noted that the diagram is only part of possible patterns, and the position of the symbol can be adjusted, and a start position of the RE can also be adjusted.

In an implementation, a target pattern feature corresponding to the target pattern has a correspondence with at least one of the following: density, CDM type, the number of ports, Comb value, the number of symbols, RE offset, SL symbol type, symbol position, bandwidth, positioning requirement, sequence feature, transmission channel, transmission resource, resource pool, and BWP corresponding to the SL positioning reference signal.

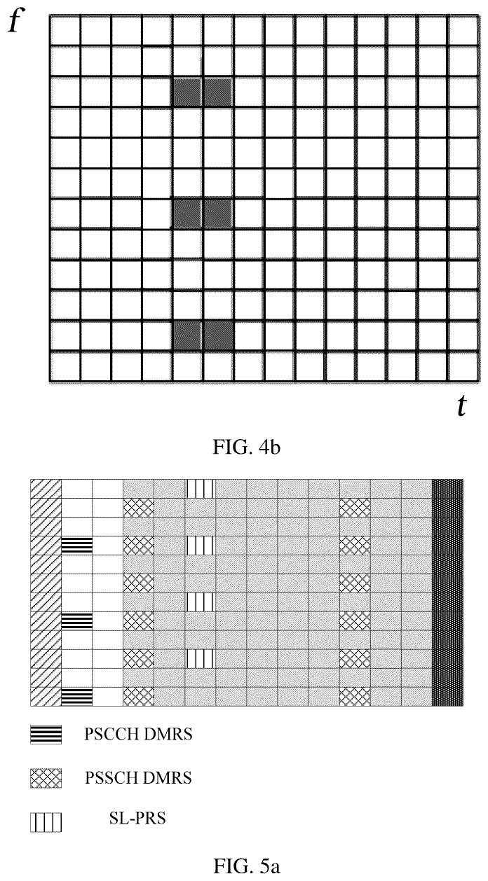

2. Pattern feature. There are two symbols for SL-PRS, and a second symbol is repetition of a first symbol, as shown in FIG. 4a and FIG. 4b.

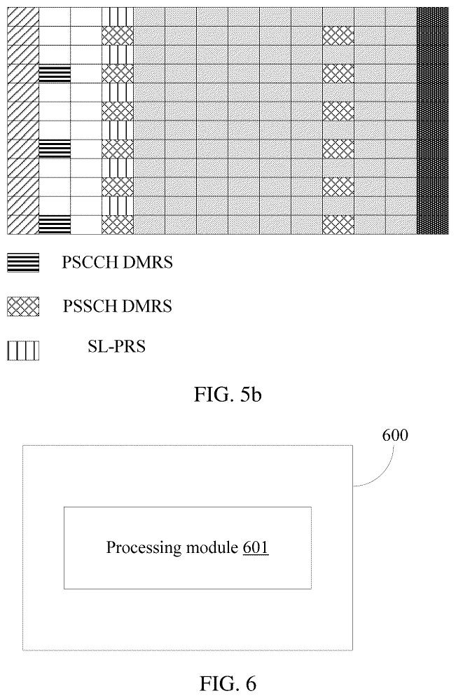

In another implementation, as shown in FIG. 5a, the SL-PRS avoids symbols such as S-SS/PBSCH/DMRS and is sent on other symbols.

In still another implementation, as shown in FIG. 5b, the SL-PRS avoids REs such as S-SS/PBSCH/DMRS and is sent on other REs.

Referring to FIG. 6, an embodiment of this application provides a positioning apparatus, applied to a terminal, and the positioning apparatus 600 includes:
a processing module 601, configured to: transmit a sidelink (SL) positioning reference signal or calculate a transport block size (TBS) based on a preset rule, where
the preset rule is used to determine a time-frequency mapping method for the SL positioning reference signal and/or a calculation method for the TBS, the SL positioning reference signal is used to determine position information of the first terminal and/or a second terminal, and the second terminal is a peer terminal that performs SL communication or SL positioning with the first terminal.

In a possible implementation, the preset rule is used to determine the time-frequency mapping method for the SL positioning reference signal, and the time-frequency mapping method includes one or more of the following:
sending the SL positioning reference signal on an orthogonal frequency division multiplexing (OFDM) symbol or a resource element (RE) other than a first position;
sending the SL positioning reference signal on an OFDM symbol or an RE after the first position;
sending the SL positioning reference signal on an OFDM symbol or an RE other than the first position;
skipping sending the SL positioning reference signal on an OFDM symbol or an RE corresponding to the first position; and
multiplexing the SL positioning reference signal at a second position, or performing, by the SL positioning reference signal, punching at the second position, where
the first position includes one or more of the following:
time domain positions of a sidelink synchronization signal block (S-SS block), a sidelink primary synchronization signal block (S-PSS block), a sidelink secondary synchronization signal block (S-SSS block), and/or a physical sidelink broadcast channel block (PSBCH block), or time-frequency positions of the S-SS block, the S-PSS block, the S-SSS block, and/or the PSBCH block;
time domain positions of a PSS, an SSS, and/or a physical broadcast synchronization channel (PBSCH), or time-frequency positions of the PSS, the SSS, and/or the PBSCH;
time domain positions/a time domain position of a physical sidelink control channel (PSCCH) and/or second-level sidelink control information (SCI), or time-frequency positions/a time-frequency position of the PSCCH and/or the second-level SCI;
time domain positions/a time domain position of a sidelink channel-state information reference signal (SL-CSI-RS) and/or an SL-TPRS, or time-frequency positions/a time-frequency position of the SL-CSI-RS and/or the SL-TPRS;
time domain positions/a time domain position of a CSI-RS and/or a demodulation reference signal (DMRS), or time-frequency positions/a time-frequency position of the CSI-RS and/or the DMRS; and
time domain positions of automatic gain control (AGC), a GP, and/or a physical sidelink feedback channel (PSFCH), or time-frequency positions of the AGC, the GP, and/or the PSFCH.

It should be noted that in an embodiment, the automatic gain control (AGC) can be understood as that two or more symbols send the same content, that is, a symbol 2 is repetition of a symbol 1.

The second position includes one or more of the following:
a position of a physical sidelink control channel (PSSCH);
a position of SL data;
a position of uplink (UL) data; and
a position of a physical uplink shared channel (PUSCH).

In a possible implementation, the preset rule includes one or more of the following:
the second-level SCI performs punching on the SL positioning reference signal;
the second-level SCI performs rate matching on the SL positioning reference signal;
a PSFCH performs punching on the SL positioning reference signal; and
the PSFCH performs rate matching on the SL positioning reference signal.

In a possible implementation, the sending the SL positioning reference signal on an RE other than a first position includes:
sending the SL positioning reference signal on the OFDM symbol corresponding to the first position, and sending other SL information on the OFDM symbol corresponding to the first position through FDM or CDM.

In a possible implementation, the preset rule includes one or more of the following:
the SL positioning reference signal is continuously sent on a frequency domain physical resource block (PRB), an RE, or a symbol other than a third position;
the SL positioning reference signal is continuously sent on a frequency domain PRB, an RE, or a symbol after the third position;
the SL positioning reference signal is sent on a frequency domain PRB, an RE, or a symbol other than the third position;
the SL positioning reference signal is not sent on a PRB, an RE, or a symbol corresponding to the third position; and
the SL positioning reference signal is multiplexed at a fourth position, or the SL positioning reference signal performs punching at the fourth position;
the third position includes one or more of the following:
frequency domain positions of an S-SS block, an S-PSS block, an S-SSS block, and/or a PSBCH block, or time-frequency positions of the S-SS block, the S-PSS block, the S-SSS block, and/or the PSBCH block;
frequency domain positions of a PSS, an SSS, and/or a PBSCH, or time-frequency positions of the PSS, the SSS, and/or the PBSCH;
frequency domain positions/a frequency domain position of a PSCCH and/or second-level SCI, or time-frequency positions/a time-frequency position of the PSCCH and/or the second-level SCI;
frequency domain positions/a frequency domain position of a CSI-RS and/or a DMRS, or time-frequency positions/a time-frequency position of the CSI-RS and/or the DMRS; and
frequency domain positions of AGC, a GP, and/or a PSFCH, or time-frequency positions of the AGC, the GP, and/or the PSFCH; and
the fourth position includes one or more of the following:
a position of a PSSCH;
a position of SL data;
a position of UL data; and
a position of a PUSCH.

In a possible implementation, the preset rule is used to determine a first calculation method for the TBS;
the first calculation method includes:
when the first terminal calculates an RE of an available resource, subtracting an overhead of the SL positioning reference signal, where a calculation formula is as follows:

N′_{RE}=N_{sc}^{RB}(N_{symb}^{sh}−N_{symb}^{PSFCH})−Nₒₕ^{PRB}−N_{RE}^{DMRS}−N_{RE}^{SL-PRS}, where
N_{sc}^{RB} is the number of REs in one RB, N_{symb}^{sh} is the number of symbols scheduled in one slot, N_{symb}^{PSFCH} is the number of symbols in a PSFCH, Nₒₕ^{PRB} is a higher layer configuration parameter, N_{RE}^{DMRS} is an overhead of a DMRS, and N_{RE}^{SL-PRS} is an overhead of the SL positioning reference signal; and
the overhead of the SL positioning reference signal includes any one or more of the following:
the overhead of the SL positioning reference signal is 0 or a preset value;
the overhead of the SL positioning reference signal is an actual overhead on the symbol;
the overhead of the SL positioning reference signal is an average overhead on the symbol;
the overhead of the SL positioning reference signal is a quantized value of the actual overhead on the symbol;
the overhead of the SL positioning reference signal is related to configuration information of the SL positioning reference signal or a pattern of the SL positioning reference signal;
the overhead of the SL positioning reference signal is an overhead of the SL positioning reference signal configured by a higher layer;
the overhead of the SL positioning reference signal is an overhead of the SL positioning reference signal indicated by SCI;
the overhead of the SL positioning reference signal is to subtract the overhead of the SL positioning reference signal when determining, based on first indication information, that the first terminal calculates an RE of an available resource, or to keep the overhead of the SL positioning reference signal when determining that the first terminal calculates the RE of the available resource; and
the overhead of the SL positioning reference signal is to subtract the overhead of the SL positioning reference signal when determining, based on condition information, that the first terminal calculates an RE of an available resource of a resource, or to keep the overhead of the SL positioning reference signal when determining that the first terminal calculates the RE of the available resource, where the condition information is a configuration and/or the number of the SL positioning reference signals.

In a possible implementation, the preset rule is used to determine a second calculation method for the transport block size (TBS);
the second calculation method includes any one or more of the following:
when the first terminal calculates an RE of an available resource on a PRB, subtracting an overhead of the SL positioning reference signal and being multiplied by a scaling factor, where a calculation formula is as follows:

N′_{RE}=N_{sc}^{RB}(N_{symb}^{sh}−N_{symb}^{PSFCH})−Nₒₕ^{PRB}−N_{RE}^{DMRS}−N_{RE}^{SL-PRS}×alpha, where
alpha is a scaling factor of N_{RE}^{SL-PRS};
the overhead of the SL positioning reference signal includes any one or more of the following:
the overhead of the SL positioning reference signal is 0 or a preset value;
the overhead of the SL positioning reference signal is an actual overhead on the symbol;
the overhead of the SL positioning reference signal is an average overhead on the symbol;
the overhead of the SL positioning reference signal is a quantized value of the actual overhead on the symbol;
the overhead of the SL positioning reference signal is related to configuration information of the SL positioning reference signal or a pattern of the SL positioning reference signal;
the overhead of the SL positioning reference signal is an overhead of the SL positioning reference signal configured by a higher layer;
the overhead of the SL positioning reference signal is an overhead of the SL positioning reference signal indicated by SCI;
the overhead of the SL positioning reference signal is to subtract the overhead of the SL positioning reference signal when determining, based on first indication information, that the first terminal calculates an RE of an available resource, or to keep the overhead of the SL positioning reference signal when determining that the first terminal calculates the RE of the available resource; and
the overhead of the SL positioning reference signal is to subtract the overhead of the SL positioning reference signal when determining, based on condition information, that the first terminal calculates an RE of an available resource of a resource, or to keep the overhead of the SL positioning reference signal when determining that the first terminal calculates the RE of the available resource, where the condition information is a configuration and/or the number of the SL positioning reference signals;
performing, by the first terminal, scaling on a scheduled PRB, and calculating the total number of REs, where a calculation formula is as follows:

N_{RE}=min(A,N′_{RE})·alpha, where

A is a preset parameter; and alpha is a scaling factor of the scheduled PRB; and
performing, by the first terminal, scaling on intermediate information of the TBS obtained through calculation, where a calculation formula is as follows:

N_{info}—N_{RE}·R·Qₘ·v·alpha, where
R is a code rate, Qₘ is a modulation order, v is the number of transport layers; and alpha is a scaling factor of the intermediate information of the TBS.

In a possible implementation, the preset rule includes a third calculation rule of the TBS of the SL positioning reference signal; and
the third calculation rule includes any one of the following:
in a case that the SL positioning reference signal is mapped on a non-PSSCH resource or a non-scheduling resource, the first terminal calculates the overhead of the resource and subtracts the overhead of the SL positioning reference signal, and a calculation formula is as follows:

N′_{RE}=N_{sc}^{RB}(N_{symb}^{sh}−N_{symb}^{PSFCH})−Nₒₕ^{PRB}−N_{RE}^{DMRS}−N_{RE}^{SL-PRS}, where
N_{RE}^{SL-PRS} is associated with an RE or a symbol of the SL positioning reference signal on the PSSCH resource or a scheduling resource; or
the calculation formula is as follows:

N′_{RE}=N_{sc}^{RB}(N_{symb}^{sh}−N_{symb}^{PSFCH})−Nₒₕ^{PRB}−N_{RE}^{DMRS}−N_{RE}^{SL-PRS}+compensation value, where
a compensation value includes: values of the SL positioning reference signal and second-level SCI and/or a value of an overlapping part of a PSSCH; or
the compensation value includes a recalculated part.

In a possible implementation, in a case that the number of transport layers is greater than 1, the preset rule includes any one of the following:
the first terminal repeatedly sends or maps the SL positioning reference signal on a plurality of transport layers; and
the first terminal sends or maps the SL positioning reference signal of a plurality of code division or OCCs on the plurality of transport layers.

In a possible implementation, the preset rule includes second indication information, and the second indication information is used to determine that initial transmission and retransmission of the SL positioning reference signal are consistent; and
the second indication information includes one or more of the following:
first-level SCI or second-level SCI indicates an overhead of the SL positioning reference signal;
a higher layer configures the overhead of the SL positioning reference signal;
indication information of the SL positioning reference signal or configuration information of the SL positioning reference signal; and
first information, used to indicate that a configuration and/or a pattern of the SL positioning reference signal sent for many times are/is consistent in a case that a resource of the SL positioning reference signal sent for many times is used for retransmission;
or,
second information, where in a case that the second information is a first value, the second information indicates that a configuration and/or a pattern of the SL positioning reference signal sent for many times are/is consistent in a case that a resource of the SL positioning reference signal sent for many times is used for retransmission.

In a possible implementation, the processing module is further configured to:
expect that the number of REs occupied by the SL positioning reference signal in initial transmission is consistent with the number of REs occupied by the SL positioning reference signal in retransmission; or
expect, based on indication of a network side, that the number of REs occupied by the SL positioning reference signal in initial transmission is consistent with the number of REs occupied by the SL positioning reference signal in retransmission.

In a possible implementation, in a case that the number of REs occupied by the SL positioning reference signal in initial transmission is not consistent with the number of REs occupied by the SL positioning reference signal in retransmission, the processing module is further configured to:
receive third indication information from the second terminal, where the third indication information is used to determine that a TBS of the SL positioning reference signal in initial transmission is consistent with the TBS of the SL positioning reference signal in retransmission.

In a possible implementation, the processing module is further configured to:
determine the overhead of the SL positioning reference signal configured by the higher layer, and the indication information or the condition information of the SL positioning reference signal in one or more of the following manners:
being determined by the first terminal based on SCI;
being determined by the first terminal based on RRC configuration negotiation or RRC feedback;
being determined by the first terminal based on PC5 RRC configuration negotiation or RRC feedback;
being determined by the first terminal based on LPP configuration negotiation feedback;
being determined by the first terminal based on PC5 LPP configuration negotiation feedback;
in a case that a PSFCH period is a preset period or a preset configuration, being determined by the first terminal based on a PSFCH overhead indication carried in SCI; and
in a case that the preset configuration is met, being determined by the first terminal based on an overhead indication of the SL positioning reference signal carried in the SCI.

The positioning apparatus provided in this embodiment of this application can implement the processes implemented in the method embodiment shown in FIG. 2 and achieve a same technical effect. To avoid repetition, details are not described herein again.

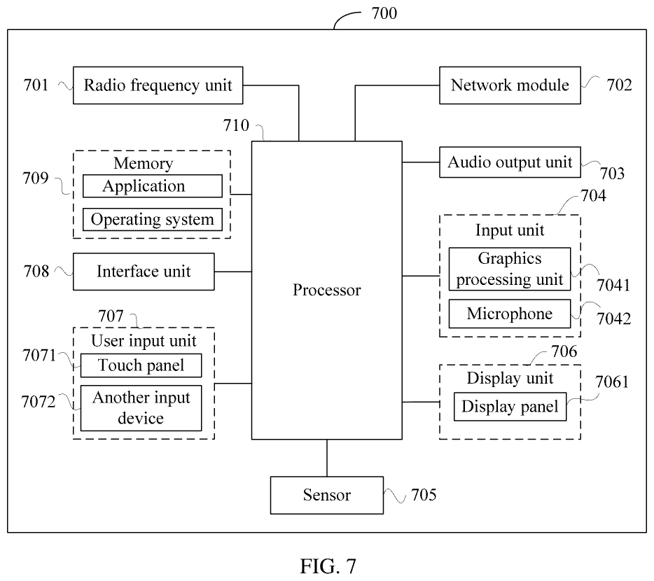

FIG. 7 is a schematic diagram of a hardware structure of a terminal according to an embodiment of this application.

A terminal 700 includes but is not limited to components such as a radio frequency unit 701, a network module 702, an audio output unit 703, an input unit 704, a sensor 705, a display unit 706, a user input unit 707, an interface unit 708, a memory 709, and a processor 710.

A person skilled in the art can understand that the terminal 700 may further include a power supply (such as a battery) that supplies power to each component. The power supply may be logically connected to the processor 710 by using a power supply management system, to implement functions such as charging and discharging management, and power consumption management by using the power supply management system. The terminal structure shown in FIG. 7 constitutes no limitation on the terminal, and the terminal may include more or fewer components than those shown in the figure, or combine some components, or have different component arrangements. Details are not described herein.

It should be understood that in this embodiment of this application, the input unit 704 may include a graphics processing unit (GPU) 7041 and a microphone 7042. The graphics processing unit 7041 processes image data of a static picture or a video obtained by an image capture apparatus (for example, a camera) in a video capture mode or an image capture mode. The display unit 706 may include a display panel 7061, and the display panel 7061 may be configured in a form of a liquid crystal display, an organic light-emitting diode, or the like. The user input unit 707 includes a touch panel 7061 and another input device 7072. The touch panel 7061 is also referred to as a touchscreen. The touch panel 7061 may include two parts: a touch detection apparatus and a touch controller. The another input device 7072 may include but is not limited to a physical keyboard, a functional button (such as a volume control button or a power on/off button), a trackball, a mouse, and a joystick. Details are not described herein.

In this embodiment of this application, the radio frequency unit 701 receives downlink data from a network side device and then sends the downlink data to the processor 610 for processing; and sends uplink data to the network side device. Usually, the radio frequency unit 701 includes but is not limited to an antenna, at least one amplifier, a transceiver, a coupler, a low noise amplifier, a duplexer, and the like.

The memory 709 may be configured to store a software program or an instruction and various data. The memory 709 may mainly include a program or instruction storage area and a data storage area. The program or instruction storage area may store an operating system, and an application or an instruction required by at least one function (for example, a sound playing function or an image playing function). In addition, the memory 709 may include a high-speed random access memory, and may further include a non-volatile memory. The non-volatile memory may be a read-only memory (ROM), a programmable read-only memory (Programmable ROM, PROM), an erasable programmable read-only memory (Erasable PROM, EPROM), an electrically erasable programmable read-only memory (Electrically EPROM, EEPROM), or a flash memory, for example, at least one disk storage device, a flash memory device, or another non-volatile solid-state storage device.

The processor 710 may include one or more processing units. Optionally, an application processor and a modem processor may be integrated into the processor 710. The application processor mainly processes an operating system, a user interface, an application, an instruction, or the like. The modem processor mainly processes wireless communication, for example, a baseband processor. It can be understood that, alternatively, the modem processor may not be integrated into the processor 710.

The terminal provided in this embodiment of this application can implement the processes implemented in the method embodiment shown in FIG. 2, and achieve a same technical effect. To avoid repetition, details are not provided herein again.

An embodiment of this application further provides a computer program product. The computer program product is stored in a non-volatile storage medium, and the program product is executed by at least one processor to implement steps of the method shown in FIG. 2.

An embodiment of this application further provides a readable storage medium. The readable storage medium may be non-volatile or volatile. The readable storage medium stores a program or an instruction, and the program or the instruction is executed by a processor to implement the processes of the foregoing method embodiment shown in FIG. 2, and a same technical effect can be achieved. To avoid repetition, details are not described herein again.

The processor is a processor in the terminal in the foregoing embodiment. The readable storage medium includes a computer-readable storage medium, such as a computer read-only memory (ROM), a random access memory (RAM), a magnetic disk, or an optical disc.

An embodiment of this application further provides a chip. The chip includes a processor and a communications interface, the communications interface is coupled to the processor, and the processor is configured to run a program or an instruction of a network side device to implement the processes of the method embodiments shown in FIG. 2, and a same technical effect can be achieved. To avoid repetition, details are not described herein again.

It should be understood that the chip mentioned in this embodiment of this application may also be referred to as a system-level chip, a system chip, a chip system, or an on-chip system chip.

It should be noted that, in this specification, the term “include”, “comprise”, or any other variant thereof is intended to cover a non-exclusive inclusion, so that a process, a method, an article, or an apparatus that includes a list of elements not only includes those elements but also includes other elements which are not expressly listed, or further includes elements inherent to such process, method, article, or apparatus. An element limited by “includes a . . . ” does not, without more constraints, preclude the presence of additional identical elements in the process, method, article, or apparatus that includes the element. In addition, it should be noted that the scope of the method and the apparatus in the embodiments of this application is not limited to performing functions in an illustrated or discussed sequence, and may further include performing functions in a basically simultaneous manner or in a reverse sequence according to the functions concerned. For example, the described method may be performed in an order different from that described, and the steps may be added, omitted, or combined. In addition, features described with reference to some examples may be combined in other examples.

Based on the descriptions of the foregoing implementations, a person skilled in the art may clearly understand that the method in the foregoing embodiment may be implemented by software in addition to a necessary universal hardware platform or by hardware only. In most circumstances, the former is a preferred implementation. Based on such an understanding, the technical solutions of this application essentially, or the part contributing to the prior art may be implemented in a form of a software product. The computer software product is stored in a storage medium (for example, a ROM/RAM, a magnetic disk, or a compact disc), and includes a plurality of instructions for instructing a terminal (which may be a mobile phone, a computer, a server, an air conditioner, a network device, or the like) to perform the method described in the embodiments of this application.

The embodiments of this application are described above with reference to the accompanying drawings, but this application is not limited to the above specific implementations, and the above specific implementations are only illustrative and not restrictive. Under the enlightenment of this application, those of ordinary skill in the art can make many forms without departing from the purpose of this application and the protection scope of the claims, all of which fall within the protection of this application.

1. A positioning method, comprising:
transmitting, by a first terminal based on a preset rule, a sidelink (SL) positioning reference signal and/or calculating a transport block size (TBS), wherein
the preset rule is used to determine a time-frequency mapping method for the SL positioning reference signal and/or a calculation method for the TBS, the SL positioning reference signal is used to determine position information of the first terminal and/or a second terminal, and the second terminal is a peer terminal that performs SL communication or SL positioning with the first terminal.

2. The method according to claim 1, wherein the preset rule is used to determine the time-frequency mapping method for the SL positioning reference signal, and the time-frequency mapping method comprises one or more of the following:
sending the SL positioning reference signal on an orthogonal frequency division multiplexing (OFDM) symbol or a resource element (RE) other than a first position;
sending the SL positioning reference signal on an OFDM symbol or an RE after the first position;
sending the SL positioning reference signal on an OFDM symbol or an RE other than the first position;
skipping sending the SL positioning reference signal on an OFDM symbol or an RE corresponding to the first position; and
multiplexing the SL positioning reference signal at a second position, or performing, by the SL positioning reference signal, punching at the second position, wherein
the first position comprises one or more of the following:
time domain positions/a time domain position of a physical sidelink control channel (PSCCH) and/or second-level sidelink control information (SCI), or time-frequency positions/a time-frequency position of the PSCCH and/or the second-level SCI;
time domain positions/a time domain position of a sidelink channel-state information reference signal (SL-CSI-RS) and/or an SL-TPRS, or time-frequency positions/a time-frequency position of the SL-CSI-RS and/or the SL-TPRS;
time domain positions/a time domain position of a CSI-RS and/or a demodulation reference signal (DMRS), or time-frequency positions/a time-frequency position of the CSI-RS and/or the DMRS; and
time domain positions of automatic gain control (AGC), a guard period (GP), and/or a physical sidelink feedback channel (PSFCH), or time-frequency positions of the AGC, the GP, and/or the PSFCH; and
the second position comprises one or more of the following:
a position of a physical sidelink control channel (PSSCH);
a position of SL data;
a position of uplink (UL) data; and
a position of a physical uplink shared channel (PUSCH).

3. The method according to claim 1, wherein SL positioning reference signal symbols are sent as consecutive symbols.

4. The method according to claim 1, wherein the preset rule comprises one or more of the following:
the second-level SCI performs punching on the SL positioning reference signal;
the second-level SCI performs rate matching on the SL positioning reference signal;
a PSFCH performs punching on the SL positioning reference signal; and
the PSFCH performs rate matching on the SL positioning reference signal.

5. The method according to claim 2, wherein the sending the SL positioning reference signal on an RE other than a first position comprises:
sending the SL positioning reference signal on the OFDM symbol corresponding to the first position, and sending other SL information on the OFDM symbol corresponding to the first position through FDM or CDM.

6. The method according to claim 1, wherein the preset rule comprises one or more of the following:
the SL positioning reference signal is continuously sent on a frequency domain physical resource block (PRB), an RE, or a symbol other than a third position;
the SL positioning reference signal is continuously sent on a frequency domain PRB, an RE, or a symbol after the third position;
the SL positioning reference signal is sent on a frequency domain PRB, an RE, or a symbol other than the third position;
the SL positioning reference signal is not sent on a PRB, an RE, or a symbol corresponding to the third position; and
the SL positioning reference signal is multiplexed at a fourth position, or the SL positioning reference signal performs punching at the fourth position;
the third position comprises one or more of the following:
frequency domain positions of an S-SS block, an S-PSS block, an S-SSS block, and/or a PSBCH block, or time-frequency positions of the S-SS block, the S-PSS block, the S-SSS block, and/or the PSBCH block;
frequency domain positions of a PSS, an SSS, and/or a PBSCH, or time-frequency positions of the PSS, the SSS, and/or the PBSCH;
frequency domain positions/a frequency domain position of a PSCCH and/or second-level SCI, or time-frequency positions/a time-frequency position of the PSCCH and/or the second-level SCI;
frequency domain positions/a frequency domain position of a CSI-RS and/or a DMRS, or time-frequency positions/a time-frequency position of the CSI-RS and/or the DMRS; and
frequency domain positions of AGC, a GP, and/or a PSFCH, or time-frequency positions of the AGC, the GP, and/or the PSFCH; and
the fourth position comprises one or more of the following:
a position of a PSSCH;
a position of SL data;
a position of UL data; and
a position of a PUSCH.

7. The method according to claim 1, wherein the preset rule is used to determine a first calculation method for the TBS;
the first calculation method comprises:
when the first terminal calculates an RE of an available resource, subtracting an overhead of the SL positioning reference signal;
the overhead of the SL positioning reference signal comprises any one or more of the following:
the overhead of the SL positioning reference signal is 0;
the overhead of the SL positioning reference signal is an overhead of the SL positioning reference signal indicated by SCI.

8. The method according to claim 1, wherein the preset rule is used to determine a second calculation method for a transport block size (TBS);
the second calculation method comprises any one or more of the following:
when the first terminal calculates an RE of an available resource on a PRB, subtracting an overhead of the SL positioning reference signal and being multiplied by a scaling (scaling) factor, wherein a calculation formula is as follows:
N′_{RE}=N_{sc}^{RB}(N_{symb}^{sh}−N_{symb}^{PSFCH})−Nₒₕ^{PRB}−N_{RE}^{DMRS}−N_{RE}^{SL-PRS}×alpha, wherein
alpha is the scaling factor of N_{RE}^{SL_PRs}, wherein
the overhead of the SL positioning reference signal comprises any one or more of the following:
the overhead of the SL positioning reference signal is 0 or a preset value;
the overhead of the SL positioning reference signal is an actual overhead on the symbol;
the overhead of the SL positioning reference signal is an average overhead on the symbol;
the overhead of the SL positioning reference signal is a quantized value of the actual overhead on the symbol;
the overhead of the SL positioning reference signal is related to configuration information of the SL positioning reference signal or a pattern of the SL positioning reference signal;
the overhead of the SL positioning reference signal is an overhead of the SL positioning reference signal configured by a higher layer;
the overhead of the SL positioning reference signal is an overhead of the SL positioning reference signal indicated by SCI;
the overhead of the SL positioning reference signal is to subtract the overhead of the SL positioning reference signal when determining, based on first indication information, that the first terminal calculates an RE of an available resource, or to keep the overhead of the SL positioning reference signal when determining that the first terminal calculates the RE of the available resource; and
the overhead of the SL positioning reference signal is to subtract the overhead of the SL positioning reference signal when determining, based on condition information, that the first terminal calculates an RE of an available resource of a resource, or to keep the overhead of the SL positioning reference signal when determining that the first terminal calculates the RE of the available resource, wherein the condition information is a configuration and/or the number of the SL positioning reference signals;
performing, by the first terminal, scaling on a scheduled PRB, and calculating the total number of REs, wherein a calculation formula is as follows:
N_{RE}=min(A,N′_{RE})·alpha, wherein
A is a preset parameter; and alpha is a scaling factor of the scheduled PRB; and
performing, by the first terminal, scaling on intermediate information of the TBS obtained through calculation, wherein a calculation formula is as follows:
N_{info}—N_{RE}·R·Qₘ·v·alpha, wherein
R is a code rate, Qₘ is a modulation order, v is the number of transport layers; and alpha is a scaling factor of the intermediate information of the TBS.

9. The method according to claim 1, wherein the preset rule comprises a third calculation rule of the TBS of the SL positioning reference signal; and
the third calculation rule comprises:
the first terminal calculates an overhead of a resource and subtracts the overhead of the SL positioning reference signal.

10. The method according to claim 1, wherein in a case that the number of transport layers is greater than 1, the preset rule comprises any one of the following:
the first terminal repeatedly sends or maps the SL positioning reference signal on a plurality of transport layers; and
the first terminal sends or maps the SL positioning reference signal of a plurality of code division or orthogonal cover codes (OCC) on the plurality of transport layers.

11. The method according to claim 1, wherein the preset rule comprises second indication information, and the second indication information is used to determine that initial transmission and retransmission of the SL positioning reference signal are consistent; and
the second indication information comprises one or more of the following:
first-level SCI or second-level SCI indicates an overhead of the SL positioning reference signal;
a higher layer configures the overhead of the SL positioning reference signal;
indication information of the SL positioning reference signal or configuration information of the SL positioning reference signal;
first information, used to indicate that a configuration and/or a pattern of the SL positioning reference signal sent for many times are/is consistent in a case that a resource of the SL positioning reference signal sent for many times is used for retransmission; and
second information, wherein in a case that the second information is a first value, the second information indicates that a configuration and/or a pattern of the SL positioning reference signal sent for many times are/is consistent in a case that a resource of the SL positioning reference signal sent for many times is used for retransmission.

12. The method according to claim 1, wherein the method further comprises:
expecting, by the first terminal, that the number of REs occupied by the SL positioning reference signal in initial transmission is consistent with the number of REs occupied by the SL positioning reference signal in retransmission; or
expecting, by the first terminal based on indication of a network side, that the number of REs occupied by the SL positioning reference signal in initial transmission is consistent with the number of REs occupied by the SL positioning reference signal in retransmission.

13. The method according to claim 1, wherein in a case that the number of REs occupied by the SL positioning reference signal in initial transmission is not consistent with the number of REs occupied by the SL positioning reference signal in retransmission, the method further comprises:
receiving, by the first terminal, third indication information from the second terminal, wherein the third indication information is used to determine that a TBS of the SL positioning reference signal in initial transmission is consistent with the TBS of the SL positioning reference signal in retransmission, wherein
the third indication information comprises one or more of the following:
first-level SCI or second-level SCI indicates an overhead of the SL positioning reference signal;
a higher layer configures the overhead of the SL positioning reference signal;
indication information of the SL positioning reference signal or configuration information of the SL positioning reference signal; and
second information, used to indicate that a configuration and/or a pattern of the SL positioning reference signal sent for many times are/is consistent in a case that a resource of the SL positioning reference signal sent for many times is used for retransmission.

14. The method according to claim 7, wherein the method further comprises:
determining the overhead of the SL positioning reference signal configured by the higher layer, and the indication information or the condition information of the SL positioning reference signal in one or more of the following manners:
being determined by the first terminal based on SCI;
being determined by the first terminal based on RRC configuration negotiation or RRC feedback;
being determined by the first terminal based on PC5 RRC configuration negotiation or RRC feedback;
being determined by the first terminal based on LPP configuration negotiation feedback;
being determined by the first terminal based on PC5 LPP configuration negotiation feedback;
in a case that a PSFCH period is a preset period or a preset configuration, being determined by the first terminal based on a PSFCH overhead indication carried in SCI; and
in a case that the preset configuration is met, being determined by the first terminal based on an overhead indication of the SL positioning reference signal carried in the SCI.

15. A terminal, wherein the terminal is a first terminal, comprising: a processor, a memory, and a program that is stored in the memory and that can run on the processor, wherein the program, when executed by the processor, causes the terminal to perform:
transmitting, based on a preset rule, a sidelink (SL) positioning reference signal and/or calculating a transport block size (TBS), wherein
the preset rule is used to determine a time-frequency mapping method for the SL positioning reference signal and/or a calculation method for the TBS, the SL positioning reference signal is used to determine position information of the first terminal and/or a second terminal, and the second terminal is a peer terminal that performs SL communication or SL positioning with the first terminal.

16. The terminal according to claim 15, wherein the preset rule is used to determine the time-frequency mapping method for the SL positioning reference signal, and the time-frequency mapping method comprises one or more of the following:
sending the SL positioning reference signal on an orthogonal frequency division multiplexing (OFDM) symbol or a resource element (RE) other than a first position;
sending the SL positioning reference signal on an OFDM symbol or an RE after the first position;
sending the SL positioning reference signal on an OFDM symbol or an RE other than the first position;
skipping sending the SL positioning reference signal on an OFDM symbol or an RE corresponding to the first position; and
multiplexing the SL positioning reference signal at a second position, or performing, by the SL positioning reference signal, punching at the second position, wherein
the first position comprises one or more of the following:
time domain positions/a time domain position of a physical sidelink control channel (PSCCH) and/or second-level sidelink control information (SCI), or time-frequency positions/a time-frequency position of the PSCCH and/or the second-level SCI;
time domain positions/a time domain position of a sidelink channel-state information reference signal (SL-CSI-RS) and/or an SL-TPRS, or time-frequency positions/a time-frequency position of the SL-CSI-RS and/or the SL-TPRS;
time domain positions/a time domain position of a CSI-RS and/or a demodulation reference signal (DMRS), or time-frequency positions/a time-frequency position of the CSI-RS and/or the DMRS; and
time domain positions of automatic gain control (AGC), a guard period (GP), and/or a physical sidelink feedback channel (PSFCH), or time-frequency positions of the AGC, the GP, and/or the PSFCH; and
the second position comprises one or more of the following:
a position of a physical sidelink control channel (PSSCH);
a position of SL data;
a position of uplink (UL) data; and
a position of a physical uplink shared channel (PUSCH).

17. The terminal according to claim 15, wherein SL positioning reference signal symbols are sent as consecutive symbols.

18. The terminal according to claim 15, wherein the preset rule is used to determine a first calculation method for the TBS;
the first calculation method comprises:
when the first terminal calculates an RE of an available resource, subtracting an overhead of the SL positioning reference signal;
the overhead of the SL positioning reference signal comprises any one or more of the following:
the overhead of the SL positioning reference signal is 0;
the overhead of the SL positioning reference signal is an overhead of the SL positioning reference signal indicated by SCI.

19. The terminal according to claim 15, wherein the preset rule comprises a third calculation rule of the TBS of the SL positioning reference signal; and
the third calculation rule comprises:
the first terminal calculates an overhead of a resource and subtracts the overhead of the SL positioning reference signal.

20. A non-transitory readable storage medium, wherein the non-transitory readable storage medium stores a program or an instruction, wherein the program or the instruction, when executed by a processor, causes the processor to perform:
transmitting, by a first terminal based on a preset rule, a sidelink (SL) positioning reference signal and/or calculating a transport block size (TBS), wherein
the preset rule is used to determine a time-frequency mapping method for the SL positioning reference signal and/or a calculation method for the TBS, the SL positioning reference signal is used to determine position information of the first terminal and/or a second terminal, and the second terminal is a peer terminal that performs SL communication or SL positioning with the first terminal.
